(19) United States
(12) Patent Application Publication
(10) Pub. No.: US 2016/0117095 A1
(43) Pub. Date: Apr. 28, 2016

(54) VEHICLE, MULTIMEDIA APPARATUS AND CONTROLLING METHOD THEREOF

(71) Applicant: Hyundai Motor Company, Seoul (KR)

(72) Inventor: Jinyoung Choi, Anyang (KR)

(21) Appl. No.: 14/919,507

(22) Filed: Oct. 21, 2015

(30) Foreign Application Priority Data
Oct. 22, 2014 (KR) 10-2014-0143162

(51) Int. Cl. G06F 3/0488; G06F 3/16; G06F 3/041

(52) U.S. Cl. CPC G06F 3/04883; G06F 3/04886; G06F 3/0412; G06F 3/167; G06F 3/0416; G06F 2203/04104

(57) ABSTRACT

A vehicle includes a touch screen detecting a position where a touch is input by a user and displaying an image corresponding to the touch; and a controller allocating text or a control command to multiple touch points when multiple touch points are detected and receiving text or a control command corresponding to at least one touch point of the multiple touch points when the at least one touch point is detected as being moved.

### CROSS-REFERENCE TO RELATED APPLICATION(S)

This application claims priority to and the benefit of under 35 U.S.C. §119(a) a Korean patent application filed on Oct. 22, 2014 in the Korean Intellectual Property Office and assigned Serial No. 10-2014-0143162, the entire disclosure of which is incorporated herein by reference.

### TECHNICAL FIELD

The present disclosure relates to a vehicle, multimedia apparatus, and control method thereof, which receives text or control commands through a touch screen.

### BACKGROUND

Vehicles are typically equipped with audio and video players for their drivers to enjoy music or video while driving, and further equipped with navigation systems for presenting the driver a rout to a destination. Recently, multimedia systems incorporating a audio and video player and a navigation system have been installed in vehicles. To this end, a text pad in the form of a keyboard is often used to input text to the multimedia apparatus. However, the driver can have difficulty in inputting text with the text pad while driving, due to the motion of the vehicle and the text pad having a small button size.

### SUMMARY

The present disclosure provides a vehicle, multimedia apparatus, and control method thereof, which receives text or control commands through touch motions.

According to embodiments of the present disclosure, a vehicle is provided. The vehicle includes a touch screen detecting a position where a touch is input by a user and displaying an image corresponding to the touch; and a controller allocating text or a control command to multiple touch points when multiple touch points are detected and receiving text or a control command corresponding to at least one touch point of the multiple touch points when the at least one touch point is detected as being moved.

The controller may be configured to display a first text input indicator on the touch screen, which sequentially displays text or a control command allocated to the at least one touch point as the at least one touch point is moved.

The controller may be further configured to control the touch screen to change text or a control command to be displayed in the first text input indicator at predetermined time intervals.

The controller may be further configured to display a second text input indicator on the touch screen, which displays all text or control commands allocated to the at least one touch point.

The vehicle may further include a sound output unit for outputting sound of text or a control command displayed in the first text input indicator.

The controller may be further configured to receive text or a control command displayed in the first text input indicator at a time when the touch is stopped.

The controller may be further configured to display text on the touch screen when the text is input.

The controller may be further configured to change an image displayed on the touch screen in response to a control command when the control command is input.

The user may be a driver of the vehicle.

Furthermore, according to embodiments of the present disclosure, a multimedia apparatus is provided. The multimedia apparatus includes a touch screen detecting a position where a touch is input by a user and displaying an image corresponding to the touch; and a controller allocating text or a control command to multiple touch points when multiple touch points are detected and receiving text or a control command corresponding to at least one touch point of the multiple touch points when the at least one touch point is detected as being moved.

The controller may be configured to display a first text input indicator on the touch screen, which sequentially displays text or a control command allocated to the at least one touch point as the at least one touch point is moved.

The controller may be further configured to control the touch screen to change text or a control command to be displayed in the first text input indicator at predetermined time intervals.

The controller may be further configured to control the touch screen to change text or a control command to be displayed in the first text input indicator in a predetermined first order, when the at least one touch point is moved in a first direction.

The controller may be further configured to control the touch screen to change text or a control command to be displayed in the first text input indicator in a predetermined second order, when the at least one touch point is moved in a second direction.

The controller may be further configured to display a second text input indicator on the touch screen, which displays all text or control commands allocated to the at least one touch point.

The controller may be further configured to control the touch screen to move the second text input indicator on the touch screen as the at least one touch point is moved.

The multimedia apparatus may further include a sound output unit for outputting sound of text or a control command displayed in the first text input indicator.

The controller may be further configured to control the sound output unit to output sound of a changed text or control command displayed in the first text input indicator, when the text or control command displayed in the first text input indicator is changed.

The controller may be further configured to receive text or a control command displayed in the first text input indicator at a time when the touch is stopped.

The controller may be further configured to display text on the touch screen when the text is input.

The controller may be further configured to change an image displayed on the touch screen in response to a control command when the control command is input.

The user may be a driver of a vehicle.

Furthermore, according to embodiments of the present disclosure, a method for controlling a multimedia apparatus is provided. The method includes: detecting at least one touch point where a touch is input by a user; allocating text or a control command to multiple touch points when multiple touch points are detected; receiving text or a control command corresponding to at least one touch point of the multiple touch points when the at least one touch point is detected as being moved; and displaying an image that corresponds to the text or control command.

The method may further include sequentially displaying text or a control command allocated to the at least one touch point as the at least one touch point is moved, when the at least one touch point is detected as being moved.

The sequentially displaying of text or a control command allocated to the at least one touch point may include changing the text or control command at predetermined time intervals.

The method may further include displaying all text or control commands allocated to the at least one touch point, when the at least one touch point is detected as being moved.

The method may further include outputting sound of text or a control command allocated to the at least one touch point, when the at least one touch point is detected as being moved.

The method may further include receiving text or a control command displayed at a time when the touch is stopped.

The displaying of the image that corresponds to the text or control command may include: displaying text when text is input; and changing the image in response to a control command when a the control command is input.

The user may be a driver of a vehicle.

Other aspects, advantages, and salient features of the disclosure will become apparent to those skilled in the art from the following detailed description, which, taken in conjunction with the annexed drawings, discloses embodiments of the disclosure

### BRIEF DESCRIPTION OF THE DRAWINGS

The above and other features and advantages of the present disclosure will become more apparent by describing in detail embodiments thereof with reference to the attached drawings in which:

FIG. 1 shows an exterior of a vehicle, according to an embodiment of the present disclosure;

FIG. 2 shows an interior of a vehicle, according to embodiments of the present disclosure;

FIG. 3 is a block diagram of a multimedia apparatus, according to embodiments of the present disclosure;

FIG. 4 is an appearance of a multimedia apparatus, according to embodiments of the present disclosure;

FIG. 5 shows an initial screen displayed by a multimedia apparatus, according to embodiments of the present disclosure;

FIG. 6 shows a navigation screen displayed by a multimedia apparatus, according to embodiments of the present disclosure;

FIG. 7 shows a destination input screen displayed by a multimedia apparatus, according to embodiments of the present disclosure;

FIG. 8 is a flow chart illustrating a method for receiving text from a driver in a multimedia apparatus, according to embodiments of the present disclosure;

FIG. 9 shows an occasion where a multimedia apparatus receives a touch motion input command from a driver, according to embodiments of the present disclosure;

FIG. 10 shows a touch motion pad displayed by a multimedia apparatus, according to embodiments of the present disclosure;

FIG. 11 is a flow chart illustrating a method for receiving text through touch motions in a multimedia apparatus, according to embodiments of the present disclosure;

FIGS. 12 to 18 show an occasion where a multimedia apparatus receives text through touch motions, according to embodiments of the present disclosure;

FIGS. 19 to 21 show another occasion where a multimedia apparatus receives text through touch motions, according to embodiments of the present disclosure;

FIGS. 22 and 23 show yet another occasion where a multimedia apparatus receives text through touch motions, according to embodiments of the present disclosure;

FIGS. 24 and 25 show still another occasion where a multimedia apparatus receives text through touch motions, according to embodiments of the present disclosure;

FIG. 26 shows a table of text and control commands assigned by a multimedia apparatus based on the number of touching fingers of a driver, according to embodiments of the present disclosure;

FIGS. 27 and 28 show an occasion where a multimedia apparatus allocates text and control commands based on the number of touching fingers, according to embodiments of the present disclosure;

FIG. 29 shows a table of text and control commands allocated by a multimedia apparatus based on the number of touching fingers, according to embodiments of the present disclosure;

FIGS. 30 and 31 show occasions where a multimedia apparatus allocates text and control commands based on the number of touching fingers, according to embodiments of the present disclosure; and

FIGS. 32 to 34 show an occasion where a multimedia apparatus receives a phone number through touch motions, according to embodiments of the present disclosure.

Throughout the drawings, like reference numerals will be understood to refer to like parts, components, and structures.

### DETAILED DESCRIPTION

The present disclosure will now be described more fully with reference to the accompanying drawings, in which embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. Like reference numerals in the drawings denote like elements, and thus their description will be omitted. In the description of the present disclosure, if it is determined that a detailed description of commonly-used technologies or structures related to the embodiments of the present disclosure may unnecessarily obscure the subject matter of the present disclosure, the detailed description will be omitted. It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

The present disclosure will now be described more fully with reference to the accompanying drawings, in which embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. Like reference numerals in the drawings denote like elements, and thus their description will be omitted. In the description of the present disclosure, if it is determined that a detailed description of commonly-used technologies or structures related to the embodiments of the present disclosure may unnecessarily obscure the subject matter of the present disclosure, the detailed description will be omitted.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components.

Embodiments of the present disclosure will now be described with reference to accompanying drawings.

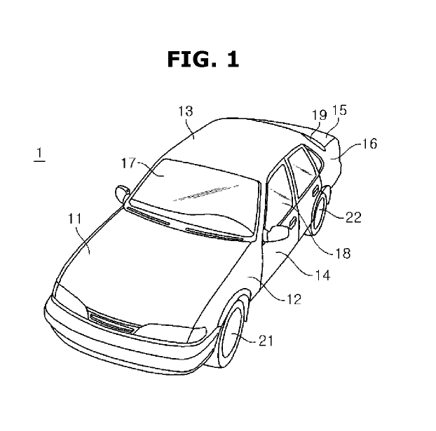

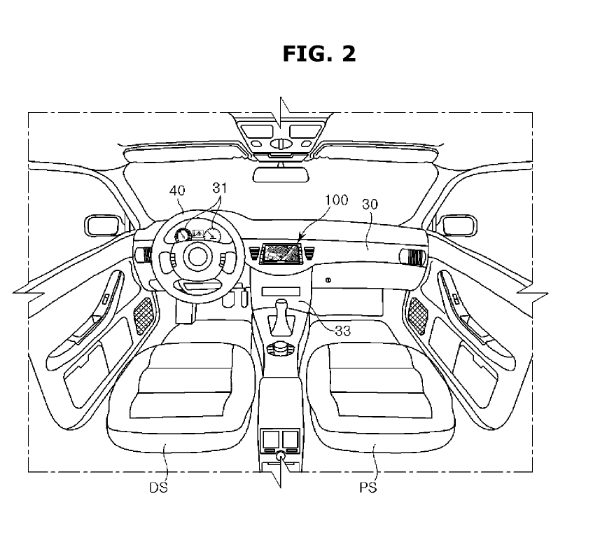

FIG. 1 shows an exterior of a vehicle, according to an embodiment of the present disclosure, and FIG. 2 shows an interior of a vehicle, according to embodiments of the present disclosure. Referring to FIGS. 1 and 2, a vehicle 1 according to embodiments includes a car frame 10 that forms the exterior of the vehicle 1, a chassis (not shown) that implements functionalities of the vehicle 1, and wheels 20 that moves the car frame 10 and the chassis.

The wheels 20 include front wheels 21 and rear wheels 22, for moving the car frame 10 and the chassis forward or backward. The body frame 10 may include a hood 11, front fenders 12, a roof panel 13, doors 14, a trunk lid 15, quarter panels 16, etc. On the exterior part of the car frame 10, there may be a front window 17 installed on the front side of the car frame 10, side windows 18 installed on the doors 14, and a rear window 19 installed on the rear side of the car frame 10.

Inside of the car frame 10, there may be seats, a dashboard 30 having various instruments and gauges for controlling the vehicle 1 and indicating driving information of the vehicle 1, and a steering wheel 40 manipulated by the driver for steering control. The seats include a driver seat (DS), a passenger seat (PS), and rear seats (not shown), and the driver seat serves the driver to manipulate the vehicle 1 in a comfortable posture.

The dashboard 30 may include an instrument cluster 31 containing gauges and indicator lights, such as a speedometer for indicating the vehicle's speed, a fuel gauge, a gearshift position indicator light, a tachometer, an odometer, etc., a center fascia 33 containing an audio control panel, Air Conditioning (AC), heater and ventilation controls, etc., and a multimedia apparatus 100 that outputs music, video, etc. The center fascia 33 is a control panel located in the center of the dash board 30 between the DS and PS, including a manipulation unit for controlling audio play, AC, heater and ventilation, a ventilator for controlling the temperature inside the vehicle 1, a cigar jack, etc.

The multimedia apparatus 100 outputs music or video according to the driver's command. Specifically, the multimedia apparatus 100 may reproduce music or video, or guide a route to a destination. Configuration and operation of the multimedia apparatus 100 will be described later in more detail. The steering wheel 40 is mounted on the dashboard 30 to be able to rotate around a steering axis, and the driver may rotate the steering wheel 40 clockwise or counterclockwise to control the moving direction of the vehicle 1.

On the chassis (not shown), there may be a power generator for generating power to move the vehicle 1 by burning the fuel, a fuel system for supplying the fuel to the power generator, a cooling system for cooling the heated power generator, an exhaust system for discharging exhaust gas produced in burning the fuel, a power transmission system for transmit the power generated by the power generator to the wheels 20, a steering system for driving the wheels 20 in the moving direction steered by the steering wheel 40 by the driver's manipulation, a brake system for slowing down the vehicle 1 or braking it to a halt, a suspension system for absorbing vibration of the wheels 20 caused by the road, etc.

The external and internal configuration of the vehicle 1 has been described above. Embodiments of the multimedia apparatus 100 will now be described below.

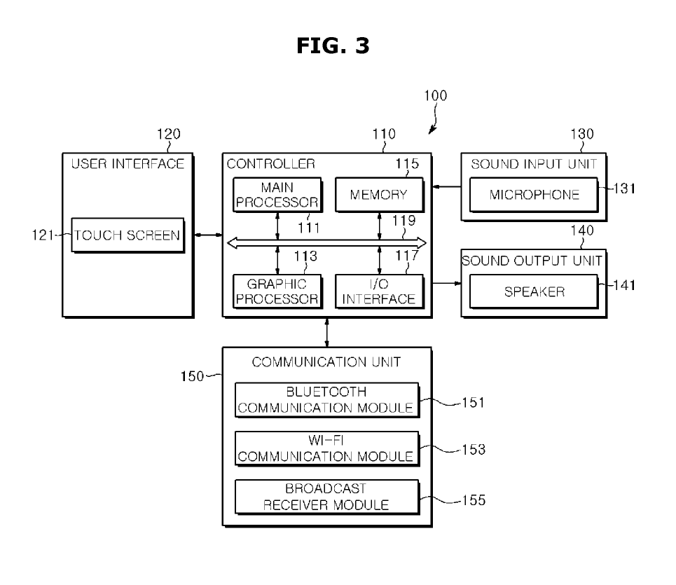

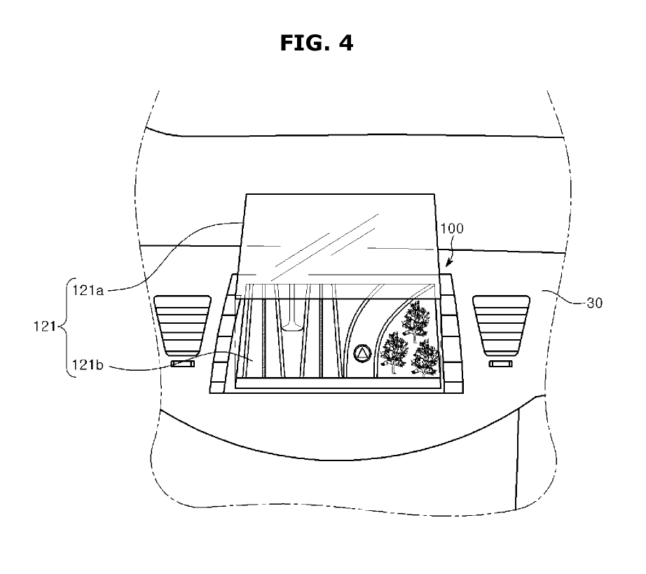

FIG. 3 is a block diagram of a multimedia apparatus, according to embodiments of the present disclosure, and FIG. 4 is an appearance of a multimedia apparatus, according to embodiments of the present disclosure.

Referring to FIGS. 3 and 4, the multimedia apparatus 100 may include a user interface 120 for interacting with the driver, a sound input unit 130 for receiving sound, a sound output unit 140 for outputting sound, a communication unit 150 for communicating with an external device, and a controller 110 for controlling general operation of the multimedia apparatus 100. The user interface 120 may be mounted on the front of the multimedia apparatus 100, as shown in FIG. 4, and include a touch screen 121 for receiving control commands from the driver and present various image information in response to the driver's control command. The image information may be visually presented to the driver.

The touch screen 121 may include a touch panel 121a for detecting whether the driver has made a touch and coordinates of the driver's touch, a display 121b for displaying image information, and a touch screen controller (not shown) for controlling operation of the touch screen 121. The display 121b displays an image according to image data received from the controller 110 as will be described below. In other words, the display 121b outputs an optical signal that corresponds to an electrical signal received from the controller 110. For example, the display 121b may display a map to guide a route according to image data received from the controller 110, or display a menu of control commands available to the driver. The display 121b may employ a Light Emitting Diode (LED) panel, an Organic Light Emitting Diode (OLED) panel, a Liquid Crystal Display (LCD) panel, etc.

The touch panel 121a may be located on the front of the display 121b, as shown in FIG. 4, and formed of a transparent material for an optical signal output from the display 121b to pass through. The touch panel 121a may detect whether the driver has made a touch and coordinates of the driver's touch through a change in capacitance or pressure caused by the driver's touch. For example, a capacitive touch panel has a dielectric (or insulator) between two electrodes electrically separated from each other, and may detect a change in capacitance between the two electrodes, which is caused by the driver's touch. In this regard, the touch panel may detect whether the driver has made a touch and coordinates of the driver's touch based on the change in capacitance.

A resistive touch panel may also have a dielectric between two electrodes electrically separated from each other. In this case, the two electrodes come into contact with each other by the driver's touch, and accordingly electrical resistance between the two electrodes changes. The touch panel may detect whether the driver has made a touch and coordinates of the driver's touch through detection of the change in electrical resistance between the two electrodes.

The touch screen controller may control the touch panel 121a to detect whether the driver has made a touch and coordinates of the driver's touch, and forward the coordinates of the driver's touch detected by the touch panel 121a to the controller 110. The touch screen controller may also receive image data from the controller 110 and control the display 121b to display an image corresponding to the image data. As such, the touch screen 121 may detect whether the driver has made a touch and coordinates of the driver's touch and forward the coordinates to the controller 110. Then, the controller 110 may determine a control command from the driver according to the coordinates of the touched position received from the touch screen 121, and send image data in response to the control command to the touch screen 121. The touch screen 121 may then display an image that corresponds to the image data received from the controller 110.

The sound input unit 130 receives an acoustic signal from outside of the multimedia apparatus 100, and includes a microphone 131 that converts the acoustic signals into electrical signals. In addition, the sound input unit 130 may further include an amplifier for amplifying the electrical signals converted by the microphone 131, an Analog-to-Digital Converter (ADC) for digitizing the electrical signals, etc.

The sound output unit 140 includes a speaker 141 for converting the electrical signals to acoustic signals and outputting the acoustic signals to the outside of the multimedia apparatus 100. Moreover, the sound output unit 140 may further include a Digital-to-Analog Converter (DAC) for converting the digitized electric signals into analog signals, an amplifier for amplifying the analog signals, etc.

The communication unit 150 may transmit/receive data to/from an external device in various communication method. Specifically, the communication unit 150 may include a Wireless Fidelity (Wi-Fi) communication module 151 for accessing a Local Area Network (LAN) through e.g., an Access Point (AP), a bluetooth communication module 153 for performing one-to-one communication with an external device or one-to-multi communication with multiple external devices, and a broadcast receiver module 155 for receiving digital broadcast signals.

The controller 110 controls general operation of the multimedia apparatus 100. The controller 110 may include an input/output (I/O) interface 117 for interfacing data between the controller 110 and various components of the multimedia apparatus 100, a memory 115 for storing programs and data, a graphic processor 113 for performing image processing, and a main processor 111 for performing operations according to the program and data stored in the memory 113. The controller 110 may further include a system bus 119 for providing data sending/receiving paths among the main processor 111, graphic processor 113, memory 115, and I/O interface 117.

The I/O interface 117 may receive a control command through the user interface 120 or acoustic data from the sound input unit 130, and forward the data to the main processor 111, the graphic processor 113, or the memory 115 via the system bus 119. Furthermore, the I/O interface 117 may forward various control signals and data output from the main processor 111 to the user interface 120 or the sound output unit 140.

The memory 115 may store control programs and control data for controlling operation of the multimedia apparatus 100 or control signals output from the main processor 111, image data output from the graphic processor 113, control commands received from the user interface 120, and/or acoustic data received from the sound input unit 130. The memory 115 may include volatile memories, such as Static Random Access Memories (S-RAMs), Dynamic RAMs (D-RAMs), or the like, and non-volatile memories, such as Read Only Memories (ROMs), Erasable Programmable ROMs (EPROMs), Electrically Erasable Programmable ROMs (EEPROMs), or the like.

The non-volatile memory may serve as an auxiliary storage device for the volatile memory, store control programs and control data for controlling operation of the multimedia apparatus 100, and maintain stored data even if the multimedia apparatus 100 is powered off. The volatile memory may store control programs and control data from the non-volatile memory, control signals output from the main processor 111, image data output from the graphic processor 113, control commands received from the user interface 120, and/or acoustic data received from the sound input unit 130. Unlike the non-volatile memory, the volatile memory may lose data when the multimedia apparatus 100 is powered off.

The graphic processor 113 converts image data output by the main processor 111 or image data stored in the memory 115 into a format that may be displayed on the touch screen 121 of the user interface 120. For example, the graphic processor 113 may perform e.g., rendering in order to display three dimensional (3D) image data on the two dimensional (2D) touch screen 121 for navigation. The main processor 111 may perform operations for controlling a portable storage device 200 connected through the user interface 120, the sound input unit 130, the sound output unit 140, the internal storage device 150, a connection interface 160 based on the control program and control data stored in the memory 115.

For example, the main processor 111 may recognize a control command from the coordinates of a touch received from the touch screen 121 of the user interface 120, or may perform operations on acoustic data received through the sound input unit 130 to recognize a control command. Furthermore, the main processor 111 may output sound through the sound output unit 140 in response to the recognized control command, or may perform operations to display an image on the touch screen 121 of the user interface 120. As such, the controller 110 may control and manage the components included in the multimedia apparatus 100, and it is to be understood that the following operation of the multimedia apparatus 100 may be performed under control of the controller 110.

Configuration of the multimedia apparatus 100 has been described above. In the following description, operation of the multimedia apparatus 100 will be explained. In particular, it will be described how to receive text from the driver in the multimedia apparatus 100.

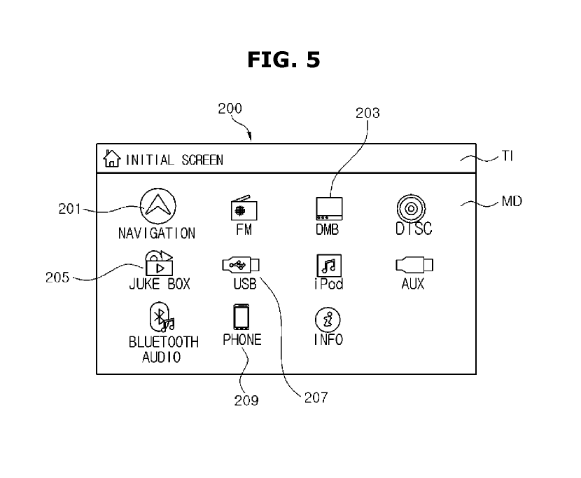

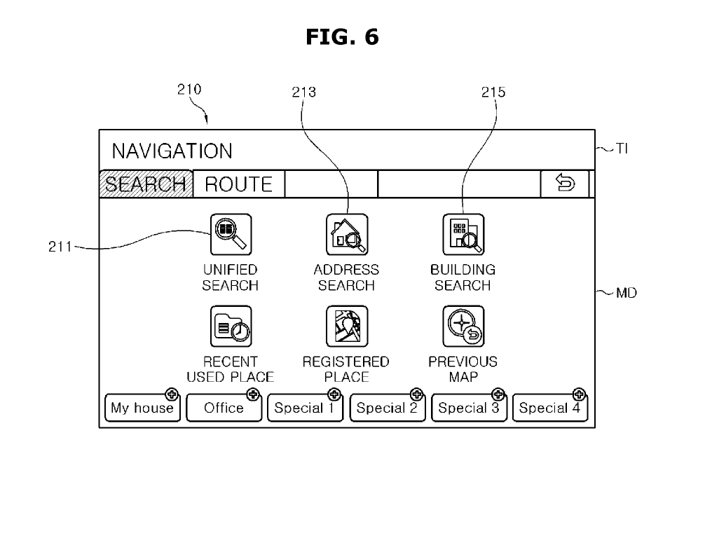

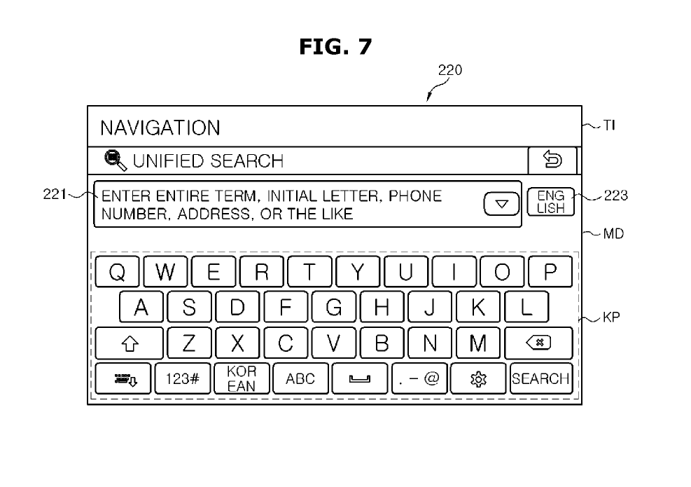

FIG. 5 shows an initial screen displayed by a multimedia apparatus, according to embodiments of the present disclosure, FIG. 6 shows a navigation screen displayed by a multimedia apparatus, according to embodiments of the present disclosure, and FIG. 7 shows a destination input screen displayed by a multimedia apparatus, according to embodiments of the present disclosure.

Referring to FIGS. 5 to 7, a screen displayed by the user interface 120 may largely include a title area TI for representing a title of the screen and a main display area MD for displaying various information in response to the driver's control command and control commands available for the driver. The initial screen 200 includes the title area TI and the main display area MD, as shown in FIG. 5. In the title area TI of the initial screen, a title, e.g., “Initial Screen” may be displayed to represent that the screen currently displayed on the touch screen 121 is an initial screen 200.

In the main display area MD, a plurality of icons 201-209 may be displayed that represent various functions that may be performed by the multimedia apparatus 100. For example, there may be a navigation icon 201 to perform the navigation function for presenting a route to a destination designated by the driver, a digital broadcasting icon 203 to receive digital broadcasts and displaying the digital broadcast content, a juke box icon 205 to play music, a Universal Serial Bus (USB) icon 207 to retrieve a file stored in an external medium (e.g., a USB storage medium), a phone icon 290 to provide the driver a calling service in cooperation with a mobile device (not shown) of the driver.

The driver may select one of the plurality of icons 201-209 in the initial screen 200 displayed on the touch screen 121 and touch the touch screen 121 at a position that corresponds to the selected icon. The touch screen 121 may detect coordinates of the driver's touch and forward the coordinates to the controller 110. The controller 110 may determine a control command input by the driver by comparing the coordinates of the driver's touch and positions of the icons on the initial screen 200.

The controller 110 forwards image data in response to the control command to the touch screen 121 which in turn displays an image corresponding to the image data received from the controller 110. For example, the driver selects the navigation icon 201 in the initial screen 200 and may touch the touch screen 121 at a position that corresponds to the navigation icon 201. The touch screen 121 detects coordinates of the driver's touch and forwards the coordinates to the controller 110.

Then, the controller 110 may determine based on the coordinates of the driver's touch that a command to execute the navigation function is input by the driver, and send the touch screen 121 image data that corresponds to a navigation screen 210 as shown in FIG. 6. As a result, the touch screen 121 may display the navigation screen 210. In the title area TI of the navigation screen, a title, e.g., “Navigation” may be displayed to represent that the screen currently displayed on the touch screen 121 is related to navigation.

In the main display area MD, a plurality of icons 211-215 may be displayed that represent various methods for receiving a destination from the driver. For example, a unified search icon 211 for searching for the destination with various search terms, such as an address, a name of a building, etc., an address search icon 213 for searching for the destination with an address of the destination, a name search icon 215 for searching for the destination with a name of the destination, etc., may be displayed in the main display area MD.

The driver may select a method for destination search by touching the navigation screen 210 at a position where the corresponding icon is displayed. For example, the driver selects the united search icon 211 in the navigation screen 210 and may touch the touch screen 121 at a position that corresponds to the united search icon 211. The touch screen 121 detects coordinates of the driver's touch and forwards the coordinates to the controller 110.

Then, the controller 110 may determine based on the coordinates of the driver's touch that a command to do united searching is input by the driver, and send the touch screen 121 the image data that corresponds to a first united search screen 220 as shown in FIG. 7. As a result, the touch screen 121 may display the first united search screen 220.

In the title area TI of the first united search screen, a title, e.g., “Navigation” may be displayed to represent that the screen currently displayed on the touch screen 121 is related to navigation. In the main display area MD of the first united search screen 220, a text pad KP for the driver to input a search term to designate a destination, a search term display area 221 for displaying text input by the driver through the text pad KP, and a language indicator area 223 for displaying a language of the input text may be presented.

The driver may input a search term through the text pad KP. When the driver touches a letter displayed on the text pad KP, the multimedia apparatus 100 may detect the coordinates of the driver's touch from the touch screen 121 and determine which letter the driver has input, based on the detected coordinates. The multimedia apparatus 100 displays the letter input by the driver in the search term display area 221.

Furthermore, if the driver inputs a complete search term and then input a search command (e.g., a complete text input command), the multimedia apparatus 100 may display a plurality of destinations associated with the search term on the touch screen 121. Then, the driver may select a destination from among the plurality of destinations displayed on the touch screen 121, and the multimedia apparatus 100 may display a route to the selected destination on the touch screen 121.

As discussed above, the multimedia apparatus 100 may receive a control command from the driver through the touch screen 121. Especially, the multimedia apparatus 100 may directly receive text from the driver through the text pad KP displayed on the touch screen 121. The multimedia apparatus 100 may receive the search term of a destination not only through the text pad KP displayed on the touch screen 121 but also through touch motions of the driver. The term touch motion as herein used refers to activities made by the driver touching the touch screen 121 and then moving the touched point. In other words, the multimedia apparatus 100 may receive the search term from the driver based on movements of the coordinates of a touch detected by the touch screen 121.

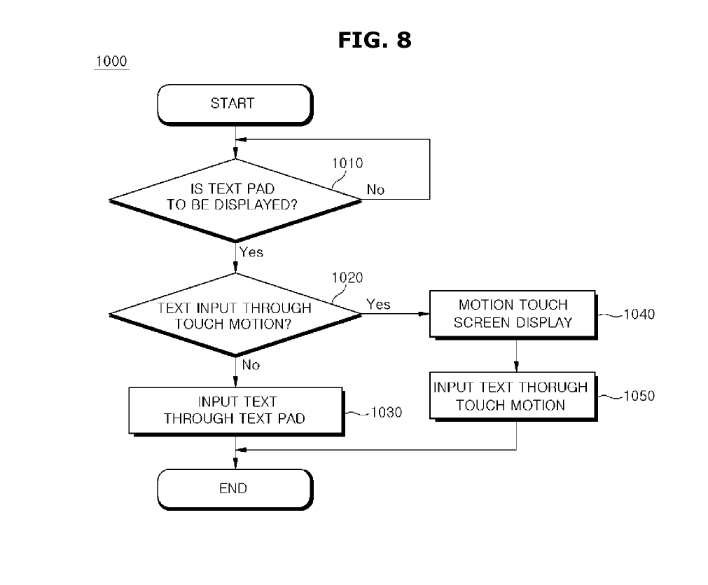

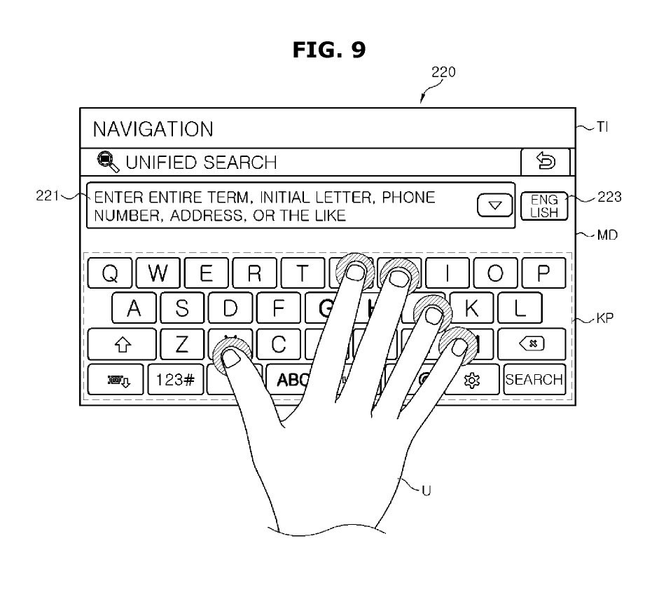

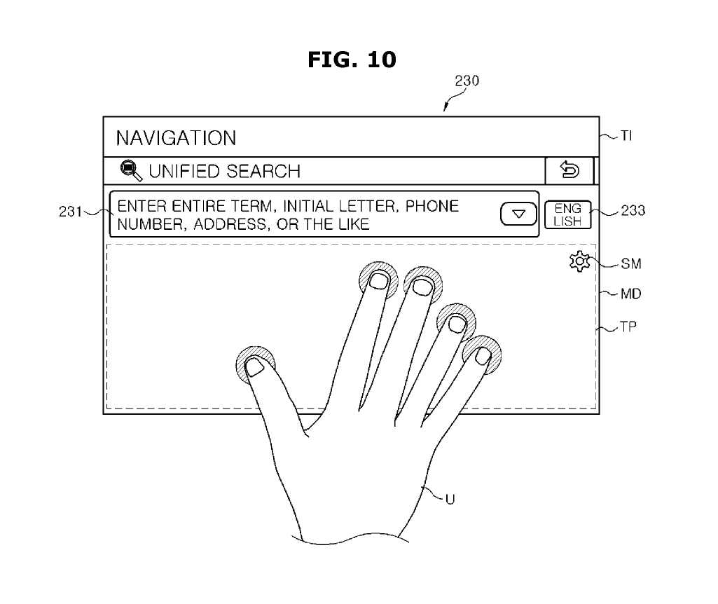

FIG. 8 is a flow chart illustrating a method for receiving text from a driver in a multimedia apparatus, according to embodiments of the present disclosure, and FIG. 9 shows an occasion where a multimedia apparatus receives a touch motion input command from a driver, according to embodiments of the present disclosure. Further, FIG. 10 shows a touch motion pad displayed by a multimedia apparatus, according to embodiments of the present disclosure.

A method 1000 for receiving text from the driver in the multimedia apparatus 100 will now be described with reference to FIGS. 8 to 10. The multimedia apparatus 100 determines whether the text pad KP is to be displayed, in operation 1010. The multimedia apparatus 100 may receive text from the driver in order to perform various functions. For example, as discussed above, the multimedia apparatus 100 may receive text from the driver in order to receive a destination while running the navigation. Moreover, the multimedia apparatus 100 may receive text from the driver in order to receive a phone number of a callee while performing a calling function that establishes a connection with a mobile device of the driver and provides a calling service for the driver. If it is determined that the character pad is to be displayed in operation 1010, the multimedia apparatus 100 determines whether to use touch motions to receive text, in operation 1020.

The multimedia apparatus 100 may receive text from the driver through the text pad KP or through touch motions according to the driver's choice. Specifically, in the text pad mode, the multimedia apparatus 100 may receive text through the text pad KP, and in the touch motion mode, the multimedia apparatus 100 may receive text through touch motions. If receiving a change input method command while in the text pad mode, the multimedia apparatus 100 may make a change to the touch motion mode.

The change input method command to change the text input mode from receiving text through the text pad KP to receiving text through touch motions may be input in various ways. For example, as shown in FIG. 9, if the driver touches multiple points while the text pad KP is displayed, the multimedia apparatus 100 may change the text pad mode to the touch motion mode. In other words, if the driver touches multiple points, the multimedia apparatus 100 may receive text through touch motions. If it is determined that text is not to be received through touch motions in operation 1020, the multimedia apparatus 100 receives text from the driver through the text pad KP displayed on the touch screen 121. Specifically, when the driver makes a touch on a position that corresponds to a letter displayed on the text pad KP, the multimedia apparatus 100 may detect the coordinates of the driver's touch from the touch screen 121 and determine which letter the driver has input by comparing the detected coordinates and a position where the letter is displayed.

If it is determined that text is to be received through the touch motion in operation 1020, the multimedia apparatus 100 displays a touch motion pad TP in operation 1040. Furthermore, the multimedia apparatus 100 changes the character pad mode to the touch motion mode. In other words, the multimedia apparatus 100 may display a second united search screen 230 that contains the touch motion pad TP on the touch screen 121. For example, as shown in FIG. 9, when the driver touches multiple points while the first united search screen 220 is displayed, the multimedia apparatus 100 displays the second united search screen 230 that contains the touch motion pad TP, as shown in FIG. 10, and changes the text input mode from the text pad mode to the touch motion mode.

In addition to the touch motion pad TP, the second united search screen 230 may also include a touch motion setting menu SM to change settings related to the text input in the touch motion mode, a search term display area 231 to display text input by the driver through the text pad KP, and a language indicator area 233 to indicate a language of the text input by the driver. Afterwards, the multimedia apparatus 100 receives text from the driver through the touch motion pad TP displayed on the touch screen 121, in operation 1050.

Embodiments of a method for receiving text through the touch motion pad TP in the multimedia apparatus 100 will be described below in more detail.

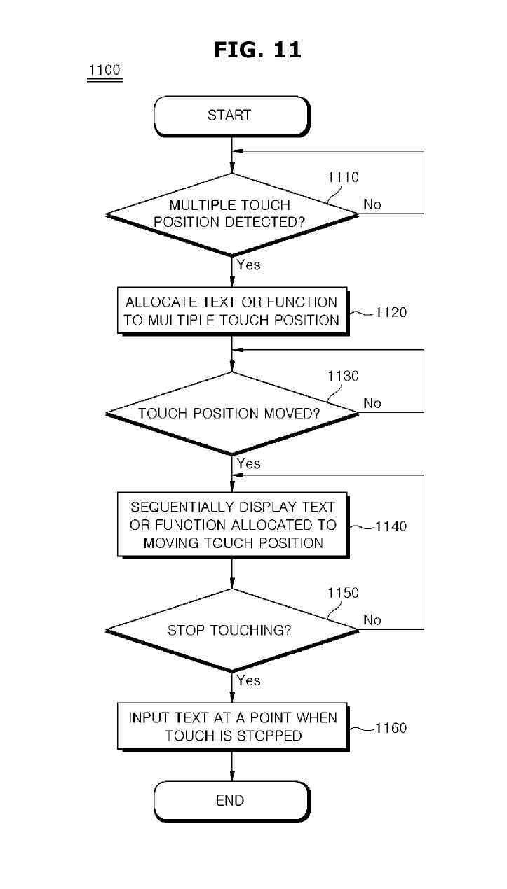

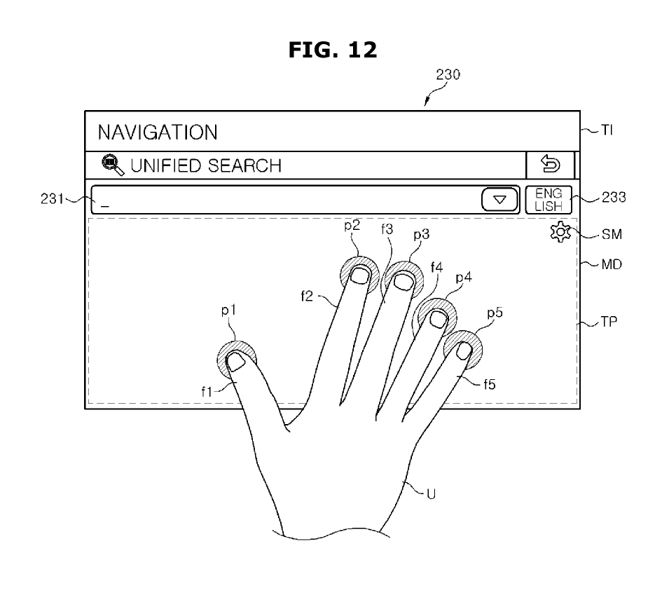

FIG. 11 is a flow chart illustrating a method for receiving text through touch motions in a multimedia apparatus, according to embodiments of the present disclosure, and FIGS. 12 to 18 show an occasion where a multimedia apparatus receives text through touch motions, according to embodiments of the present disclosure.

A method 1100 for receiving text through touch motions in the multimedia apparatus 100 will now be described with reference to FIGS. 11 to 18. The multimedia apparatus 100 determines whether touches have been detected at multiple positions, in operation 1110. As previously mentioned, if touches are detected at multiple positions while in the text pad mode, the multimedia apparatus 100 may determine that text is to be input through touch motions.

When touches have been detected at multiple positions in operation 1110, the multimedia apparatus 100 allocates letters or control commands for the multiple touch positions, in operation 1120. Once the multiple touched positions are detected, the multimedia apparatus 100 may display touch points p1-p5 corresponding to the multiple touched positions in order to indicate where the touches have been detected. For example, as shown in FIG. 12, when the driver touches the touch screen 121 of the multimedia apparatus 100 with his/her five fingers, the multimedia apparatus 100 may indicate touch points p1-p5 at positions where the touches are detected.

Specifically, the multimedia apparatus 100 may indicate a first touch point p1 at a position touched by the driver's thumb f1, a second touch point p2 at a position touched by the driver's index finger f2, a third touch point p3 at a position touched by the driver's middle finger f3, a fourth touch point p4 at a position touched by the driver's ring finger f4, and a fifth touch point p5 at a position touched by the driver's little finger f5. If the driver's seat DS is placed on the left side of the vehicle 1, it is most likely for the driver to manipulate the multimedia apparatus 100 with his/her right hand. When the touches are detected at five positions, the multimedia apparatus 100 may allocate a touch detected on the leftmost side to the first touch point p1 and a touch detected on the rightmost side to the fifth touch point p5. The multimedia apparatus 100 may allocate touches on the second, third and fourth places from the left to the second, third, and fourth touch points p2, p3, and p4, respectively. As a result, the first touch point p1 that represents the position touched by the thumb f1 is located on the leftmost side while the fifth touch point p5 that represents a position touched by the little finger f5 is located on the rightmost side. The second, third, and fourth touch points p2, p3, and p4 are located in the order from left to right. However, the embodiment is not limited thereto.

If the driver's seat DS is placed on the right side of the vehicle 1, it is most likely for the driver to manipulate the multimedia apparatus 100 with his/her left hand. When touches are detected at five positions, the multimedia apparatus 100 may allocate a touch detected on the rightmost side to the first touch point p1 and a touch detected on the leftmost side to the fifth touch point p5. The multimedia apparatus 100 may allocate touches on the second, third and fourth places from the right to the second, third, and fourth touch points p2, p3, and p4, respectively. As a result, the first touch point p1 that represents the position touched by the thumb f1 is located on the rightmost side while the fifth touch point p5 that represents the position touched by the little finger f5 is located on the leftmost side. The second, third, and fourth touch points p2, p3, and p4 are located in the order from right to left.

The multimedia apparatus 100 may determine where the thumb f1 of the driver has made a touch, based on the position where a touch has been detected. The multimedia apparatus 100 may determine a position where a touch is made on the rightmost side or on the leftmost side to be a position touched by the thumb f1. The thumb f1 is usually spaced from the index finger farther than the other adjacent fingers are. Accordingly, the multimedia apparatus 100 may compare a distance between touches made on the first and second places from the right and a distance between touches made on the first and second places from the left, and determine that the thumb f1 is placed at the first place whose distance to the adjacent second place is longer. For example, if the distance between the first and second places from the right is longer than the distance between the first and second places from the left, the multimedia apparatus 100 may determine that the thumb f1 has made a touch at the first place from the right, i.e., on the rightmost side.

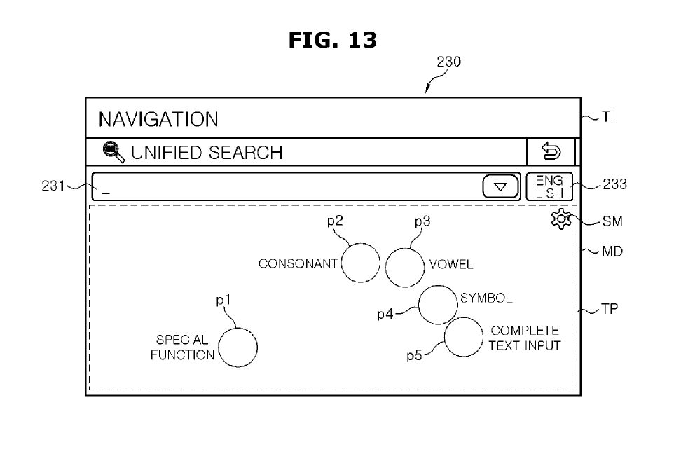

Furthermore, the multimedia apparatus 100 may allocate text or control commands to the multiple touch points p1-p5. For example, as shown in FIG. 13, the multimedia apparatus 100 may designate the first touch point p1 to input control commands, such as ‘delete’, ‘change language’, ‘transform text between uppercase and lowercase’, and the like; the second touch point p2 to input consonants; the third touch point p3 to input vowels; the fourth touch point to input numbers and symbols; and the fifth touch point p5 to input a complete text input command.

Specifically, the multimedia apparatus 100 may receive English consonants “b”, “c”, “d”, “f”, “g”, “h”, “j”, “k”, “l”, “m”, “n”, “p”, “q”, “r”, “s”, “t”, “v”, “x”, “z” or Korean consonants “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, through the second touch point p2. The multimedia apparatus 100 may also receive English vowels “a”, “e”, “i”, “o”, “u”, “w”, “y”, or Korean vowels “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, through the third touch point p3. Furthermore, the multimedia apparatus 100 may receive numbers “1”, “2”, “3”, “4”, “5” “6”, “7”, “8”, “9”, “0”, and symbols “!”, “@”, “#”, “$”, “%”, “̂”, “&”, “*”, “(”, “)”, “-”, etc., through the fourth touch point p4. However, what are allocated to the touch points p1-p5 is not limited to text or control commands as shown in FIG. 13.

For example, in the Korean input mode, the multimedia apparatus 100 may designate the first touch point p1 to input a control command, the second touch point to input an initial letter, the third touch point p3 to input a middle letter p3, and the fourth point p4 to input a final letter. The text or control commands allocated to the touch points p1-p5 may be set directly by the user. Specifically, the driver may touch the touch motion setting menu SM and then change text and control commands to be allocated to the first to fifth touched points p1-p5.

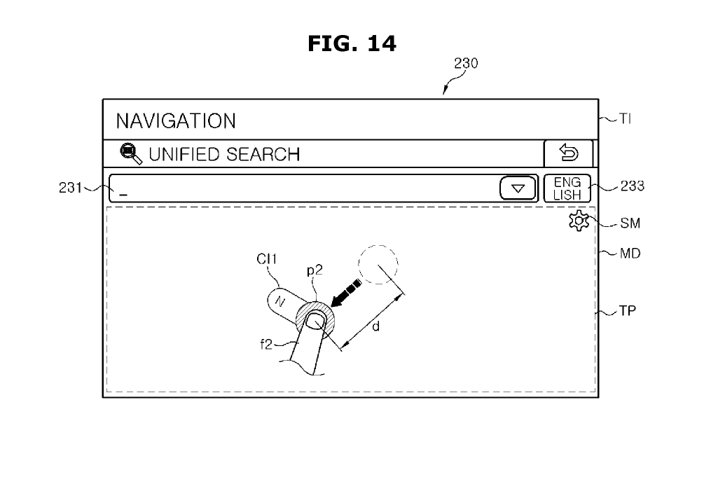

After allocation of the text or control commands to each touch point, the multimedia apparatus 100 determines whether a movement of the touch point is detected, in operation 1130. The driver may touch the touch motion pad TP displayed on the touch screen 121 with his/her fingers f1-f5, and move the touched position while holding the touch by one of the fingers f1-f5. In other words, the driver may drag the touched position. For example, as shown in FIG. 14, the driver may move his/her index finger f2 downward while holding a touch made by the index finger f2.

When the movement of the touched position is detected in operation 1130, the multimedia apparatus 100 sequentially displays text or control commands allocated for the moving touch point, in operation 1140. In other words, when the driver drags a touch point, the multimedia apparatus 100 sequentially displays text or control commands allocated for the touch point dragged. Specifically, when one of the multiple touch points is moved, the multimedia apparatus 100 may move the position of the touch point as well and sequentially display a plurality of letters or control commands allocated to the moving touch point. For example, as shown in FIG. 14, if the driver moves his/her index finger f2 downward while holding a touch by the index finger f2, the multimedia apparatus 100 moves the second touch point p2 downward along with the movement of the index finger f2.

Furthermore, the multimedia apparatus 100 may generate and display a first text input indicator C11 somewhere around the second touch point p2, and sequentially display the English or Korean consonants allocated to the second touch point p2 in the first text input indicator C11. Specifically, the multimedia apparatus 100 may sequentially display the English consonants “b”, “c”, “d”, “f”, “g”, “h”, “j”, “k”, “l”, “m”, “n”, “p”, “q”, “r”, “s”, “t”, “v”, “x”, “z” or Korean consonants “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, in the first text input indicator C11. In this regard, the first letter to be displayed in the first text input indicator C11 may be a previously input letter, or the first alphabet consonant ‘b’ or the first Korean consonant “ [symbol] ”.

Time intervals at which a plurality of letters or control commands are displayed in the first text input indicator C11 may vary by distance d between the first touched position and the current touched position. Specifically, the farther the distance d between the first touched position and the current touched position, the shorter the time interval at which the respective letters are displayed in the first text input indicator C11. In other words, as the distance d between the first touched position and the current touched position is farther, the letter displayed in the first text input indicator C11 may be swiftly changed.

On the other hand, the closer the distance d between the first touched position and the current touched position, the longer the time interval at which the respective letters are displayed in the first text input indicator C11. In other words, as the distance d between the first touched position and the current touched position is closer, the letter displayed in the first text input indicator C11 may be slowly changed. That is, the distance d between the first touched position and the current touched position and the change rate of letters to be displayed in the first text input indicator C11 are proportional to each other.

Moreover, while sequentially displaying letters in the first text input indicator C11, the multimedia apparatus 100 may output a sound of a letter displayed in the first text input indicator C11 through the sound output unit 140. For example, as shown in FIG. 14, the multimedia apparatus 100 may output a sound [en] through the sound output unit 140 while displaying Alphabet ‘N’ in the first input indicator C11.

Furthermore, if the distance d between the first touched position and the current touched position is equal to or greater than a threshold, the multimedia apparatus 100 may stop outputting the sound of a letter through the sound output unit 140. In other words, if the change rate of letters displayed in the first text input indicator C11 is equal to or greater than a predetermined threshold, the multimedia apparatus 100 may stop outputting the sound of the letter through the sound output unit 140. This is because if the time interval at which letters are displayed in the first text input indicator C11 is shorter than a time interval at which the sounds of the letters are output through the sound output unit 140, it may rather confuse the driver.

Accordingly, if the time interval at which the letters are displayed in the first text input indicator C11 is shorter than a time interval at which sounds of the letters are output through the sound output unit 140, the multimedia apparatus 100 may stop outputting the sound of the letter through the sound output unit 140. If the driver moves the touched position back in the direction opposite to the direction in which the first touched position has been moved, the multimedia apparatus 100 may stop changing letters or control commands and keep displaying a letter or control command displayed at a time when the touched position started to be moved back.

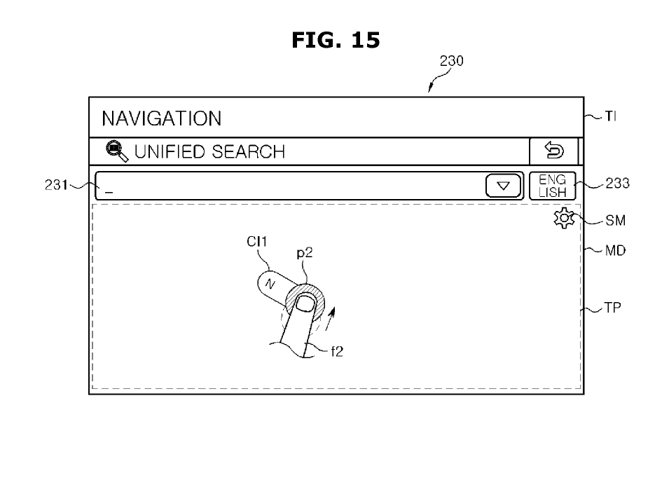

In the aforementioned example as shown in FIG. 14, if the driver drags his/her index finger f2 downward, the multimedia apparatus 100 sequentially displays English consonants in the first text input indicator C11. In this regard, as shown in FIG. 15, if the driver drags his/her index finger f2 back upward, the multimedia apparatus 100 may stop sequentially displaying the English consonants and keep displaying a letter displayed at a time when the driver started to drag the index finger f2 back upward in the first text input indicator C11. In other words, if the driver drags his/her index finger f2 back, the multimedia apparatus 100 stops changing letters to be displayed in the first text input indicator C11.

Along with this, the multimedia apparatus 100 may output a sound of the English consonant letter through the sound output unit 140, the letter being displayed in the first text input indicator C11 at a time when the driver started to drag the index finger f2 back upward. In addition, the multimedia apparatus 100 may change the order of displaying the plurality of letters (or control commands) depending on the direction in which the touched position detected is moved.

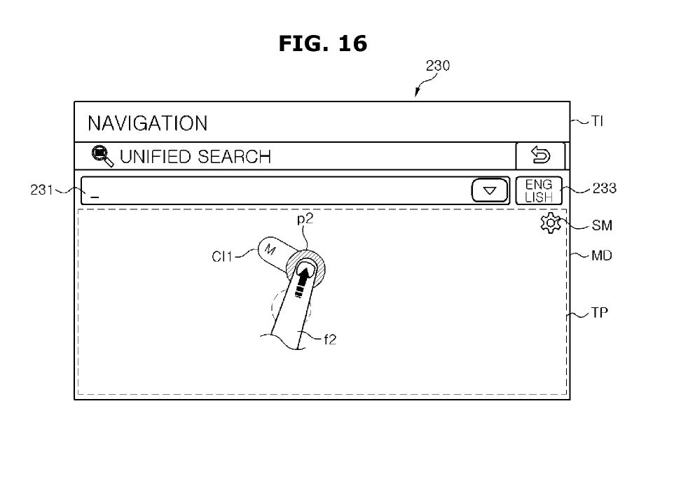

In the earlier example, if the driver moves his/her index finger f2 downward while holding a touch by the index finger f2, the multimedia apparatus 100 sequentially displays “b”, “c”, “d”, “f”, “g”, “h”, “j”, “k”, “l”, “m”, “n”, “p”, “q”, “r”, “s”, “t”, “v”, “x”, “z” in the first text input indicator C11 at predetermined time intervals. On the contrary, as shown in FIG. 16, if the driver moves his/her index finger f2 upward while holding the touch by the index finger f2, the multimedia apparatus 100 may sequentially display “z”, “x”, “v”, “t”, “s”, “r”, “q”, “p”, “n”, “m”, “l”, “k”, “j”, “h”, “g”, “f”, “d”, “c”, “b” in the first text input indicator C11 at predetermined time intervals.

In other words, if the driver drags a touch point downward, the multimedia apparatus 100 displays the letters in the first text input indicator C11 in the order, and if the driver drags a touch point upward, the multimedia apparatus 100 displays the letters in the first text input indicator C11 in the reverse order. In addition, the multimedia apparatus 100 may display the plurality of letters or control commands allocated to the moving touch point all at a time. Displaying all the plurality of letters or control commands allocated to the touch point may enable the driver to see letters or control commands available with the touch point.

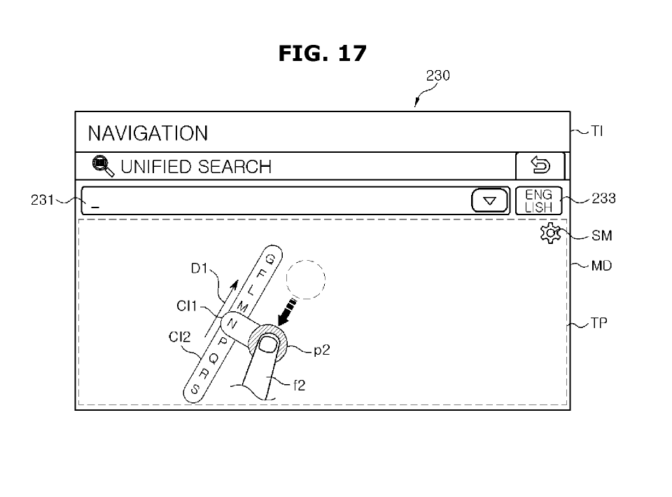

For example, as shown in FIG. 17, if the driver moves his/her index finger f2 downward while holding a touch by the index finger f2, the multimedia apparatus 100 may display a second text input indicator C12 in addition to the first text input indicator C11. In this regard, the multimedia apparatus 100 may display all the English consonants or Korean consonants allocated to the second touch point p2 in the second text input indicator C12, while sequentially displaying them in the first text input indicator C11.

More specifically, the multimedia apparatus 100 may display all the English consonants “b”, “c”, “d”, “f”, “g”, “h”, “j”, “k”, “l”, “m”, “n”, “p”, “q”, “r”, “s”, “t”, “v”, “x”, “z” in the second text input indicator C12, while sequentially displaying them one by one in the first text input indicator C11. As the letter displayed in the first text input indicator C11 is changed, the multimedia apparatus 100 may move the second text input indicator C12. Specifically, as the letter displayed in the first text input indicator C11 is changed, the multimedia apparatus 100 may move the second text input indicator C12 upward, as shown in FIG. 17.

The change rate of letters displayed in the first text input indicator C11 and the moving rate of the second text input indicator C12 may vary by the distance d between the first touched position and the current touched position. Specifically, as the distance d between the first touched position and the current touched position is farther, the letter displayed in the first text input indicator C11 may be swiftly changed and the second text input indicator C12 may be moved fast. As the distance d between the first touched position and the current touched position is closer, the letter displayed in the first text input indicator C11 may be slowly changed and the second text input indicator C12 may be slowly moved. Moreover, while sequentially displaying letters in the first text input indicator C11 and moving the second text input indicator C12, the multimedia apparatus 100 may output sounds of letters displayed in the first text input indicator C11 through the sound output unit 140. Furthermore, the multimedia apparatus 100 may display the plurality of letters in the first letter indicator C11 in different order and move the second text input indicator C12 in a different direction, based on the direction in which the touched position is moved.

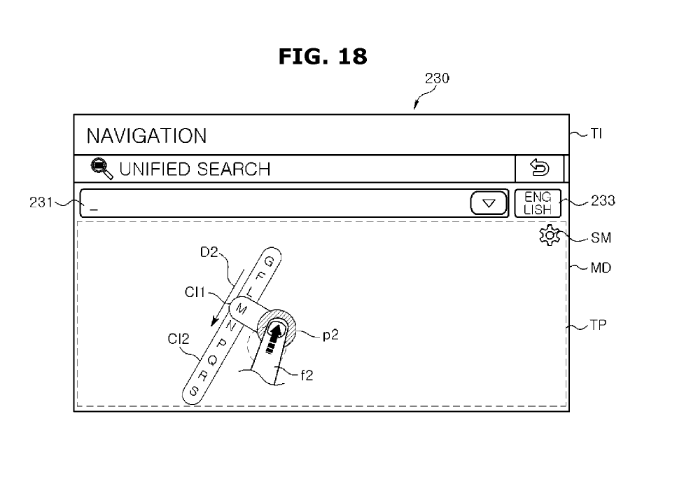

In the aforementioned example, if the driver moves his/her index finger f2 downward while holding a touch by the index finger f2, the multimedia apparatus 100 moves the second text input indicator C12 upward. On the contrary, as shown in FIG. 18, if the driver moves his/her index finger f2 upward while holding a touch by the index finger f2, the multimedia apparatus 100 may move the second text input indicator C12 downward. That is, if the driver drags a touch point downward, the multimedia apparatus 100 moves the second text input indicator C12 upward, and if the driver drags a touch point upward, the multimedia apparatus 100 moves the second text input indicator C12 downward.

While sequentially displaying letters or control commands, the multimedia apparatus 100 determines whether the driver's touch is done, in operation 1150. While the multimedia apparatus 100 is sequentially displaying the plurality of letters or control commands in the first text input indicator C11, the driver may check if a letter or control command desired by the driver appears in the first text input indicator C11. If the desired letter or control command appears in the first text input indicator C11, the driver may stop touching. For example, if ‘N’ desired by the driver appears in the first text input indicator C11 while the driver is touching the touch screen 121 with his/her index finger f2, the driver may stop touching the touch screen 121. That is, the driver may withdraw the index finger f2 from the touch screen 121.

If the driver's touch is ongoing in operation 1150, the multimedia apparatus 100 keeps sequentially displaying the plurality of letters or control commands. Otherwise, if the driver's touch is done in operation 1150, the multimedia apparatus 100 receives a letter displayed in the first text input indicator C11 at a time when the touch is done, in operation 1160. For example, if the driver withdraws his/her index finger f2 from the touch screen 121 when ‘N’ is displayed in the first text input indicator C11, the multimedia apparatus 100 may receive the letter ‘N’ and display it in the search term display area 231.

As described above, when touches are detected from multiple positions, the multimedia apparatus 100 may allocate letter(s) or control command(s) to each of the multiple touch points and receive letters or control commands through the driver's drag and drop activities. Embodiments of a method for inputting text through touch motions has been described above by taking an example of inputting consonants with the driver's index finger f2.

In accordance with the method 1100 for inputting letters through touch motions, text of English letters or Korean letters may be inputted. It is understood that the driver may input a term ranging from word to sentence by repeating the method 1100 as shown in FIG. 11.

In order for the multimedia apparatus 100 to receive a word or a sentence, a consonant allocated to the second touch point p2, a control command to the first touch point p1, a vowel to the third touch point p3, a number or symbol to the fourth touch point p4, and the complete text input command to the fifth touch point p5 need to be combined. Occasions where the driver inputs a vowel and a control command, and completes text input will now be described.

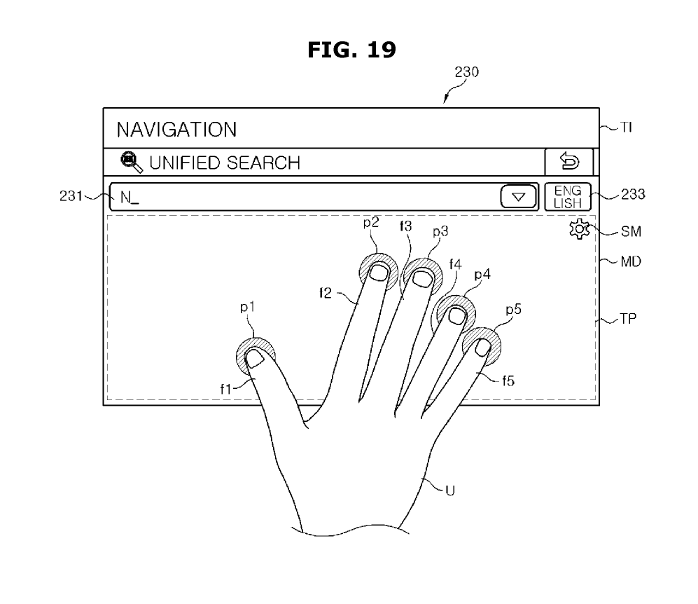

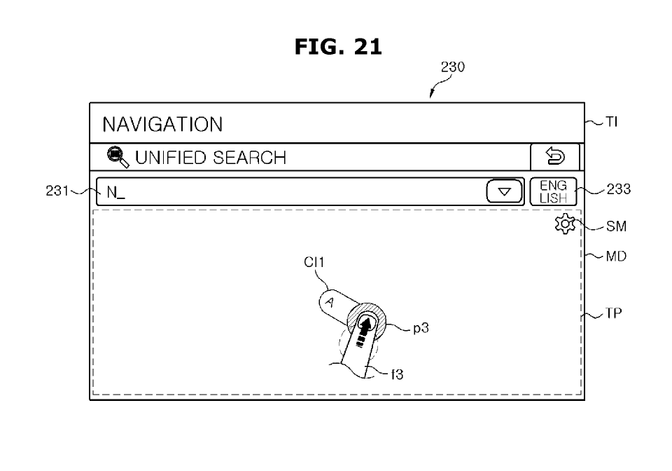

FIGS. 19 to 21 show another occasion where a multimedia apparatus receives text through touch motions, according to embodiments of the present disclosure. Referring to FIGS. 19 to 21, how the multimedia apparatus 100 receives vowels through touch motions is described.

As discussed above, inputting text begins by making multiple touches at multiple positions and ends when the touch is done. Specifically, to input new text, the driver may touch the touch screen 121 of the multimedia apparatus 100 with his/her fingers. More specifically, to input alphabet ‘E’, the driver may first touch the touch screen 121 of the multimedia apparatus 100 with his/her five fingers, as shown in FIG. 19. With the touches by the five fingers on the touch screen 121, the multimedia apparatus 100 may display touch points p1-p5 where the touches have been detected and designate the touch points p1-p5 to input letters or control commands.

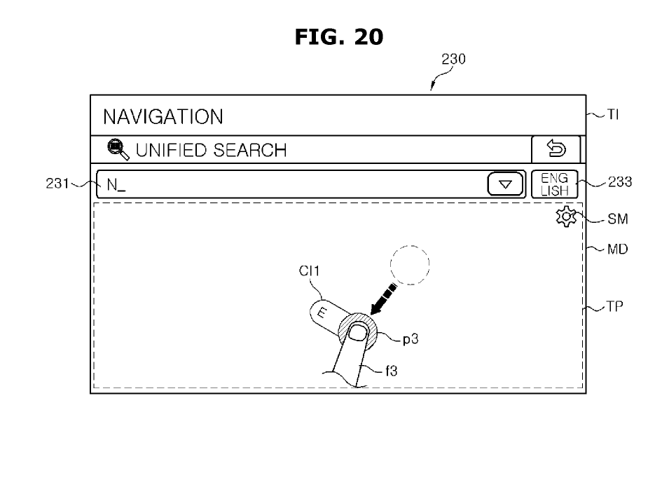

The driver who touches the touch motion pad TP displayed on the touch screen 121 with his/her fingers f1-f5 may move the middle finger f3 while holding the touch by the middle finger f3, as shown in FIG. 20. In other words, the driver may drag the touch point with the middle finger f3. If the driver drags the touch point, the multimedia apparatus 100 may generate and display the first text input indicator C11 somewhere around the third touch point p3, as shown in FIG. 20, and sequentially display English vowels or Korean vowels one by one in the first text input indicator C11.

Specifically, the multimedia apparatus 100 may sequentially display English vowels “a”, “e”, “i”, “o”, “u”, “w”, “y”, or Korean vowels “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, one by one in the first text input indicator C11. In this regard, the first letter to be displayed in the first text input indicator C11 may be a previously input letter, or the first English vowel ‘a’ or the first Korean vowel “ [symbol] ”. If the driver drags the third touch point p3 upward with the middle finger f3, the multimedia apparatus 100 may generate and display the first text input indicator C11 somewhere around the third touch point p3 and display the English vowels or Korean vowels in the first text input indicator C11 in the reverse order. Specifically, the multimedia apparatus 100 may sequentially display English vowels “y”, “w”, “u”, “o”, “i”, “e”, “a”, or Korean vowels “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ” one by one in the first text input indicator C11.

As such, while the multimedia apparatus 100 is sequentially displaying the English or Korean vowels in the first text input indicator C11, the driver may stop touching when one of the vowels desired by the driver appears in the first text input indicator C11. That is, when a desired vowel appears in the first text input indicator C11, the driver may withdraw the middle finger f3 from the touch screen 121. Once the driver withdraws the middle finger f3 from the touch screen 121, the multimedia apparatus 100 may receive a letter displayed in the first text input indicator C11 at a time when the driver withdraws the middle finger f3, and display the letter in the search term display area 231.

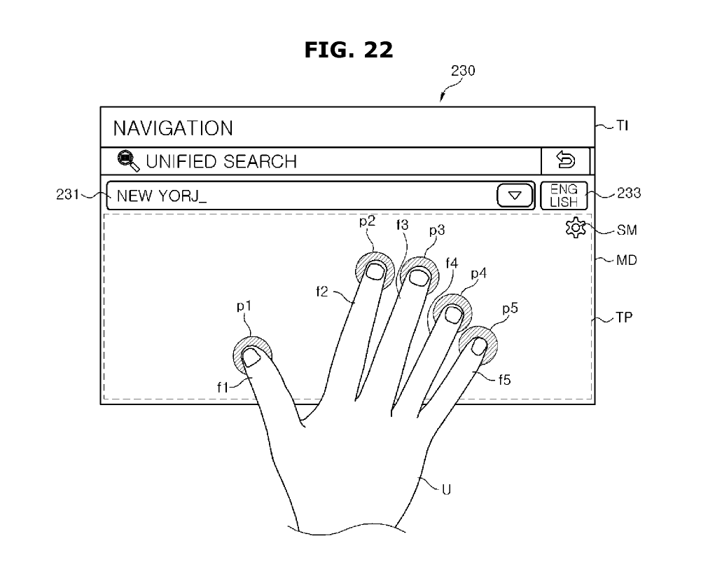

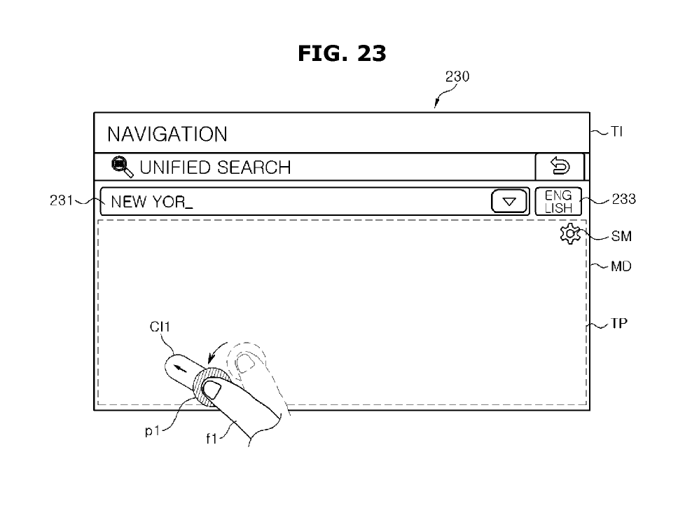

FIGS. 22 and 23 show yet another occasion where a multimedia apparatus receives text through touch motions, according to embodiments of the present disclosure. Referring to FIGS. 22 to 23, embodiments of a method for receiving text through touch motions in the multimedia apparatus 100 is described.

To input a control command, the driver may touch the touch screen 121 of the multimedia apparatus 100 with his/her fingers. Specifically, when the driver has input wrong text ‘NEW YORJ’ instead of ‘NEW YORK’, the driver may first touch the touch screen 121 of the multimedia apparatus 100 with his/her five fingers, as shown in FIG. 22. With the touches by the driver's five fingers on the touch screen 121, the multimedia apparatus 100 may display touch points p1-p5 where the touches have been detected and designate the touch points to input letters or control commands.

The driver who touches the touch motion pad TP displayed on the touch screen 121 with his/her fingers f1-f5 may move the thumb f1 to the left while holding the touch by the thumb f1, as shown in FIG. 23. In other words, the driver may drag the touch point with the thumb f1. If the driver drags the touch point, the multimedia apparatus 100 may generate and display the first text input indicator C11 somewhere around the first touch point p1, as shown in FIG. 23, and sequentially display various control commands in the first text input indicator C11. Specifically, the multimedia apparatus 100 may sequentially display control commands, such as symbols “←” indicating a ‘delete’ command, “Korean/English (or K/E)” indicating a change language command between Korean and English, and “A/a” indicating a transform text between uppercase and lowercase.

As such, while the multimedia apparatus 100 is sequentially displaying various control commands in the first text input indicator C11, the driver may stop touching when a desired control command or the corresponding symbol appears in the first text input indicator C11. That is, if a desired symbol “←” that represents a delete command appears in the first text input indicator C11, the driver may withdraw the thumb f1 from the touch screen 121. Once the driver withdraws the thumb f1 from the touch screen 121, the multimedia apparatus 100 may receive the control command represented by the corresponding symbol in the first text input indicator C11 at a time when the driver withdrew the thumb f1, and display text by reflecting the received control command in the search term display area 231.

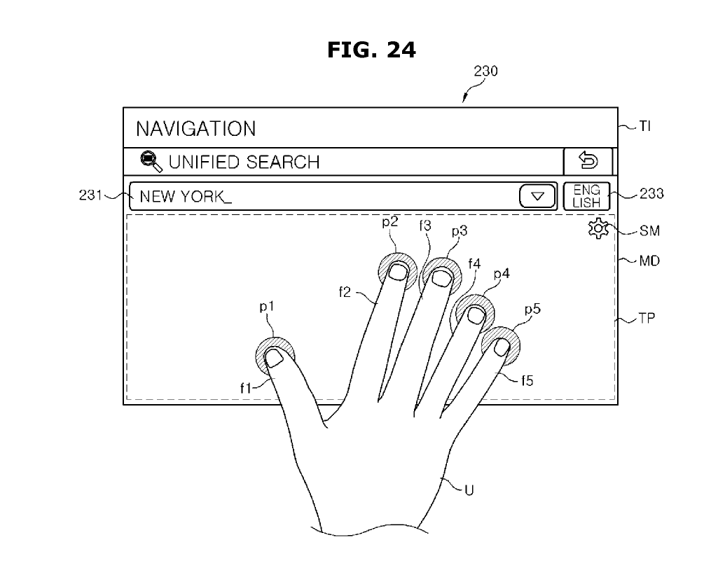

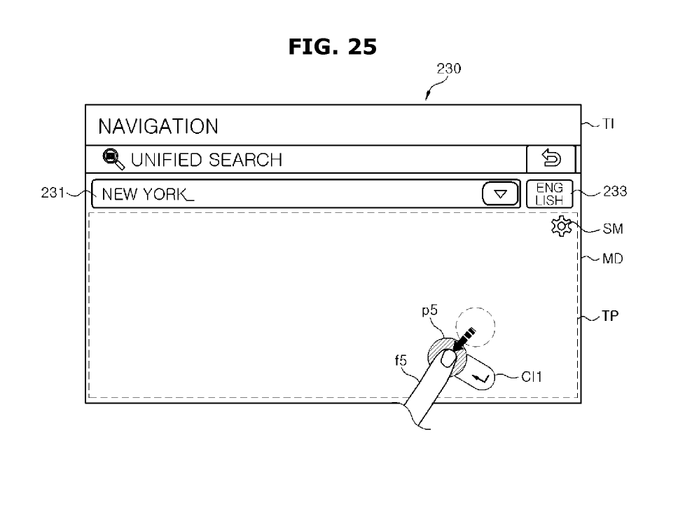

FIGS. 24 and 25 show still another occasion where a multimedia apparatus receives text through touch motions, according to embodiments of the present disclosure. Referring to FIGS. 24 and 25, how the multimedia apparatus 100 receives a complete text input command (e.g., “<Enter>”) through touch motions is described.

To input the complete text input command, the driver may first touch the touch screen 121 of the multimedia apparatus 100 with his/her fingers. Specifically, when the driver has input text “NEW YORK”, the driver may first touch the touch screen 121 of the multimedia apparatus 100 with his/her five fingers, as shown in FIG. 24. With the touches by the driver's five fingers on the touch screen 121, the multimedia apparatus 100 may display touch points p1-p5 where the touches have been detected and designate the touch points p1-p5 to input text or control commands.

The driver who has touched the touch motion pad TP displayed on the touch screen 121 with his/her fingers f1-f5 may move the little finger f5 downward while holding the touch by the little finger f5, as shown in FIG. 25. In other words, the driver may drag the touch point with the little finger f5. If the driver drags the touch point, the multimedia apparatus 100 may generate and display the first text input indicator C11 somewhere around the fifth touch point p5, as shown in FIG. 25, and display a symbol of the complete text input command, e.g., “<enter>” in the first text input indicator C11.

As such, while the multimedia apparatus 100 is displaying the symbol of the complete text input command, e.g., “<enter>” in the first text input indicator C11, the driver may stop touching. That is, the driver may withdraw the little finger f5 from the touch screen 121. When the driver withdraws the little finger f5 from the touch screen 121, the multimedia apparatus 100 may determine a word or sentence displayed in the search term display area 231 as a search term and search for destinations related to the search term.

The complete text input command may be input even with the palm of the user. In other words, after a word or sentence is input through touch motions, if the driver touches the touch motion pad TP with his/her palm, the multimedia apparatus 100 may determine the input word or sentence as a search term.

Embodiments of a method for receiving text through touch motions in the multimedia apparatus 100 were described by considering an occasion where the driver touches the touch motion pad TP displayed on the touch screen 121 with his/her five fingers. However, it is understood that the method is not limited to the occasion where the driver inputs text with five fingers. Embodiments of a method for receiving text through touch motions in the multimedia apparatus 100 based on the number of fingers that touch the touch motion pad TP displayed on the touch screen 121 will now be described.

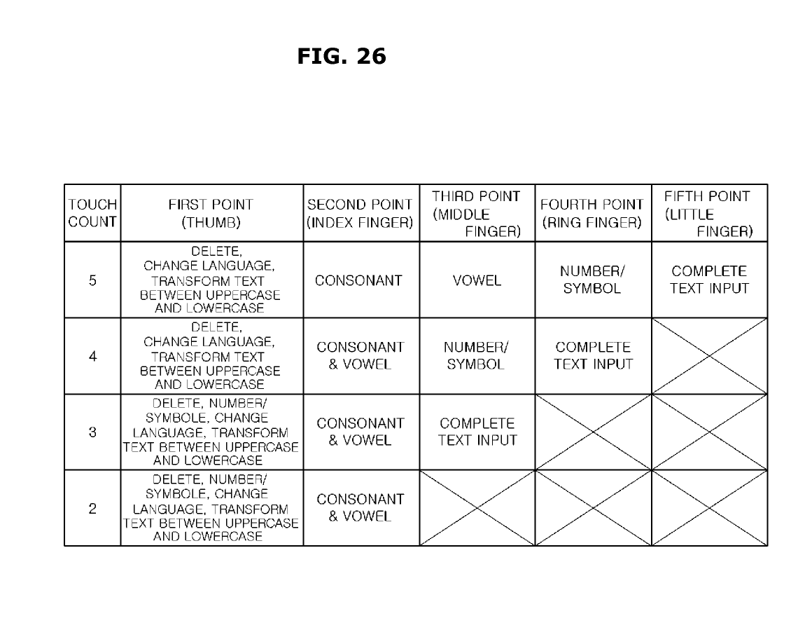

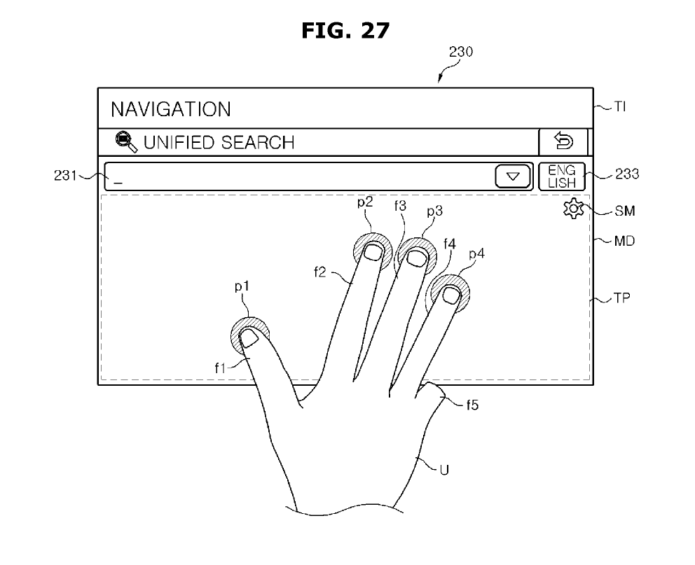

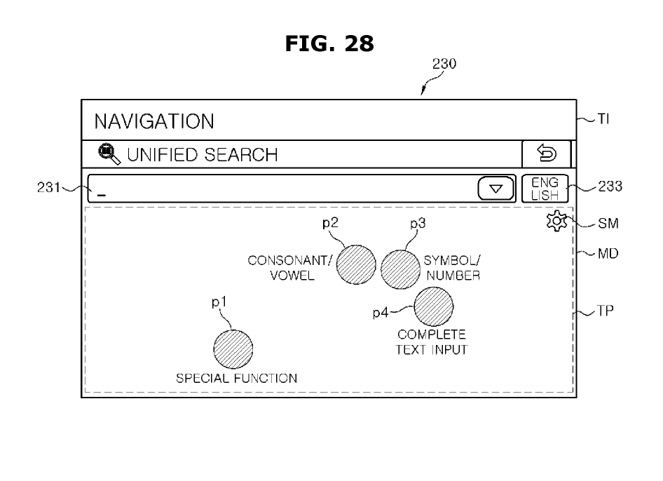

FIG. 26 shows a table of text and control commands assigned by a multimedia apparatus based on the number of touching fingers of a driver, according to embodiments of the present disclosure, and FIGS. 27 and 28 show an occasion where a multimedia apparatus allocates text and control commands based on the number of touching fingers, according to embodiments of the present disclosure.

Referring to FIGS. 26 to 28, how a multimedia apparatus 100 allocates text and control commands based on the number of touching fingers of the driver is described. As previously discussed in connection with FIG. 13, when the driver touches the touch motion pad TP with his/her five fingers f1-f5, the multimedia apparatus 100 may display touch points p1-p5 where the touches have been made with the five fingers f1-f5. Furthermore, the multimedia apparatus 100 may designate the first to fifth touch points p1-p5 to input letters or control commands. However, inputting text through the touch motion pad TP is not limited to an occasion where the driver touches the touch motion pad TP with his/her five fingers f1-f5.

Even when the driver touches the touch motion pad TP with two, three or four of his/her fingers, the multimedia apparatus 100 may display touch points where touches have been made with the two, three, or four fingers. As shown in FIG. 26, the multimedia apparatus 100 may designate the respective touch points to input letters or control commands. For example, if the driver touches the touch motion pad TP with four fingers, the multimedia apparatus 100 may display first to fifth touch points p1-p4 where the touches have been made with the four fingers of the driver, as shown in FIG. 27. Furthermore, the multimedia apparatus 100 may designate the first to fourth touched points p1-p4 to input letters or control commands. Specifically, as shown in FIG. 28, the multimedia apparatus 100 may allocate control commands, such as ‘delete’, ‘change language’, ‘transform text between uppercase and lowercase’, and the like to the first touch point p1; consonants and vowels to the second touch point p2; numbers and symbols to the third touch point p3; and the complete text input command to the fourth touch point p4.

Of course, even when the driver touches the touch motion pad TP with two or three of his/her fingers, the multimedia apparatus 100 may display touch points where the touches have been made with the two or three of his/her fingers and allocate control commands, consonants/vowels, numbers/symbols, and the complete text input command to the touch points. As shown in the table of FIG. 26, if the driver touches the touch motion pad TP with three of his/her fingers, the multimedia apparatus 100 may display first to third touch points p1-p3 where the touches have been made with the three fingers and allocate control commands/numbers/symbols, consonants/vowels, and the complete text input command to the three touched points.

In addition, as shown in the table of FIG. 26, if the driver touches the touch motion pad TP with two of his/her fingers, the multimedia apparatus 100 may display first and second touch points p1 and p2 where the touches have been made with the two fingers and allocate control commands/numbers/symbols and consonants/vowels to the two touched points. In this case, the complete text input command may be input with the palm of the user. In other words, after a word or a sentence is input through touch motions, if the driver touches the touch motion pad TP with his/her palm, the multimedia apparatus 100 may determine the input word or sentence as a search term. As such, the driver may input text to the multimedia apparatus 100 with his/her fingers, and different text or control commands may be allocated to each of the touching fingers based on the number of the touching fingers. Moreover, the driver may implement different control commands depending on the number of fingers touching the touch motion pad TP displayed on the touch screen.

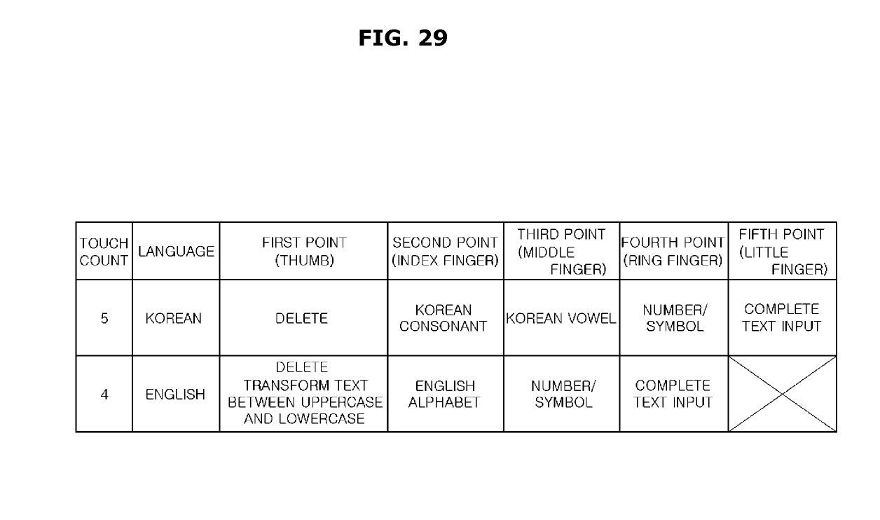

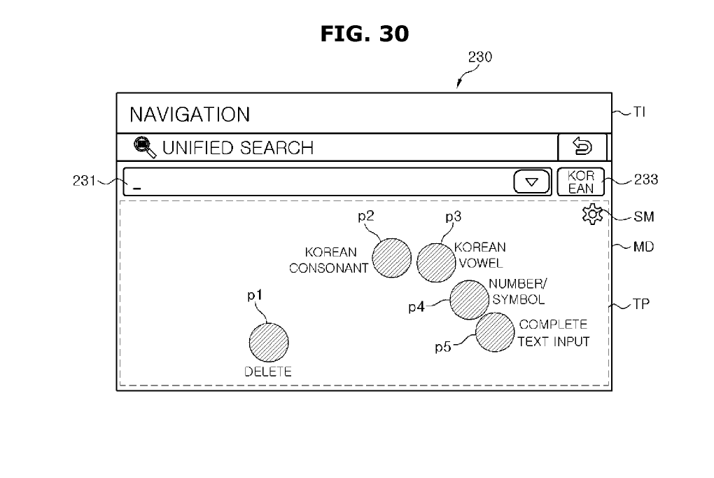

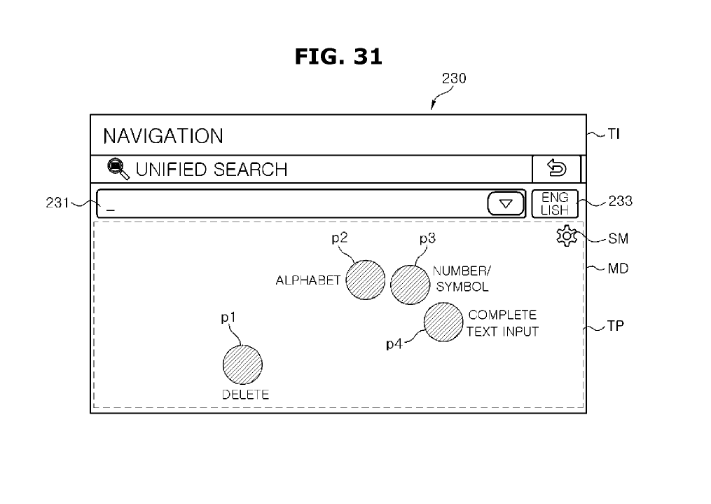

FIG. 29 shows another table of text and control commands allocated by a multimedia apparatus based on the number of touching fingers, according to embodiments of the present disclosure, and FIGS. 30 and 31 show occasions where a multimedia apparatus allocates text and control commands based on the number of touching fingers, according to embodiments of the present disclosure.

The multimedia apparatus 100 may receive a different language depending on the number of the driver's fingers touching the touch motion pad TP. For example, if the driver touches the touch motion pad TP with five fingers, the multimedia apparatus 100 may be ready to receive Korean text through the touch motion pad TP, as shown in FIGS. 29 and 30. For example, the multimedia apparatus 100 may allocate a delete command to the first touch point p1; Korean consonants to the second touch point p2; Korean vowels to the third touch point p3; numbers and symbols to the fourth touch point p4; and the complete text input command to the fifth touch point p5.

In another example, if the driver touches the touch motion pad TP with four fingers, the multimedia apparatus 100 may be ready to receive English text through the touch motion pad TP, as shown in FIGS. 29 and 31. Specifically, the multimedia apparatus 100 may allocate control commands, such as ‘delete’ and ‘transform text between uppercase and lowercase’ to the first touch point p1; English alphabets to the second touch point p2; numbers and symbols to the third touch point p3; and the complete text input command to the fourth touch point p4.

To sum up, if the driver touches the touch motion pad TP with five fingers, the multimedia apparatus 100 may be ready to receive Korean text; and if the driver touches the touch motion pad TP with four fingers, the multimedia apparatus 100 may be ready to receive English text. In yet another example, if the driver touches the touch motion pad TP with three fingers, the multimedia apparatus 100 may be ready to receive English capital letters. As such, depending on the number of fingers that touch the touch motion pad TP, the multimedia apparatus 100 may implement different control commands, such as ‘change language’ or ‘transform text between upper case and lower case’.

In the above embodiments, inputting text or control commands through touch motions was described by taking an example of inputting a destination in the navigation mode. However, inputting text or control commands through touch motions is not limited thereto. For example, the multimedia apparatus 100 may use touch motions to input telephone numbers in a calling mode.

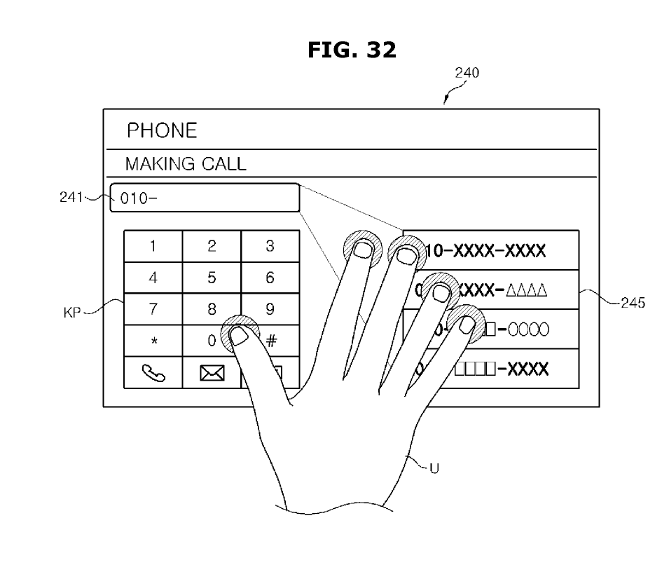

FIGS. 32 to 34 show an occasion where a multimedia apparatus receives a phone number through touch motions, according to embodiments of the present disclosure.

If the driver selects the phone icon 209 in the initial screen 200 shown in FIG. 5, the multimedia apparatus 100 may provide a calling service to the driver in cooperation with the driver's mobile device (not shown). Especially, if the driver tries to call somebody, the multimedia apparatus 100 may display a first calling screen 240 on the touch screen 121 as shown in FIG. 32. The first call screen 240 may include a title area TI and a main display area MD. In the title area TI, a title of the calling service of the multimedia apparatus 100, e.g., “PHONE” may be displayed.

In the main display area MD of the first call screen 240, a numeric pad KP for inputting a phone number of the callee, a phone number display area 241 for displaying numbers input by the driver, and a search result display area 245 for displaying a phone number searched for by the numbers input by the driver. The driver may input the phone number of a callee using the numeric pad KP. When the driver touches a number displayed on the numeric pad KP, the multimedia apparatus 100 may detect the coordinates of the driver's touch from the touch screen 121 and determine which number the driver has input, based on the detected coordinates. The multimedia apparatus 100 displays the number input by the driver in the phone number display area 241.

If the driver inputs a complete phone number and then inputs a command to make a call (e.g., the complete text input command), the multimedia apparatus 100 may send a call request to a mobile device of a callee designated by the phone number in cooperation with the mobile device of the driver. The multimedia apparatus 100 may receive the phone number not only through the numeric pad KP displayed on the touch screen 121 but also through touch motions of the driver. In other words, the multimedia apparatus 100 may receive the phone number from the driver in response to movements of the touch coordinates detected from the touch screen 121.

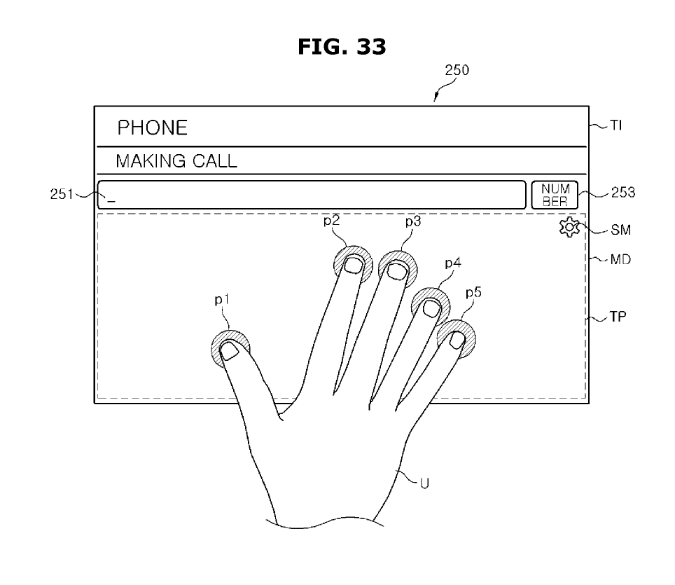

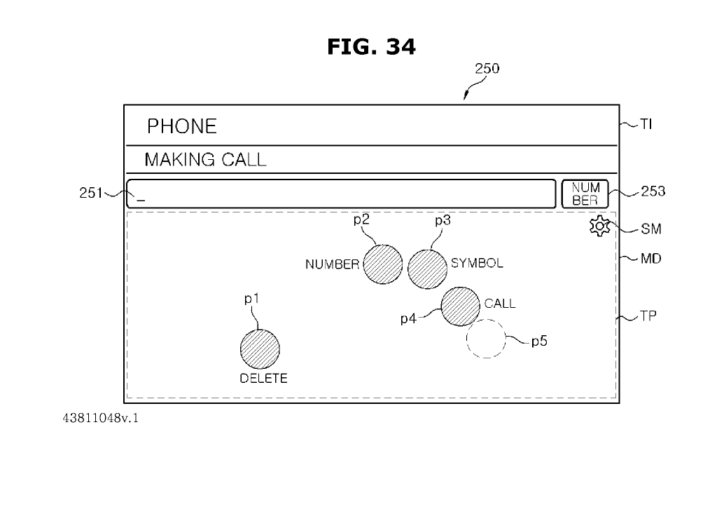

Specifically, if the driver touches the touch screen 121 with his/her fingers while the first call screen 240 is displayed on the touch screen 121 as shown in FIG. 32, the multimedia apparatus 100 may display a second call screen 250 including the touch motion pad TP, as shown in FIG. 33. The multimedia apparatus 100 may display touch points p1-p5 where the touches have been made and designate the touch points p1-p5 to input text or control commands. For example, as shown in FIG. 34, the multimedia apparatus 100 may allocate a delete command to the first touch point p1 touched by the driver's thumb f1; numbers to the second touch point p2 touched by the driver's index finger f2; symbols, such as ‘*’ and ‘#’ to the third touch point p3 touched by the driver's middle finger f3; and a connect call command to the fourth touch point touched by the driver's ring finger f4.

The multimedia apparatus 100 may not allocate any number or control command to the fifth touch point p5 touched by the little finger f5 and indicate it as being inactivated. Since the phone number is comprised only of a combination of numbers and symbols, there is no need to allocate any further number or control command to the fifth touch point p5. Accordingly, the multimedia apparatus 100 inactivate the fifth touch point p5 and indicates it as being inactivated. As such, the multimedia apparatus 100 may input text not only using the text pad KP for inputting text letter by letter but also using the touch motion pad TP for inputting text through touch motions.

According to embodiments of the present disclosure, a vehicle, multimedia apparatus, and control method thereof may be provided, which receives text or control commands through touch motions by allocating text or control commands to multiple touch positions and receiving text or a control command allocated to a moving touch position. Several embodiments have been described, but a person of ordinary skill in the art will understand and appreciate that various modifications can be made without departing the scope of the present disclosure. Thus, it will be apparent to those ordinary skilled in the art that the disclosure is not limited to the embodiments described, which have been provided only for illustrative purposes.

What is claimed is:

1. A vehicle comprising:
a touch screen detecting a position where a touch is input by a user and displaying an image corresponding to the touch; and
a controller allocating text or a control command to multiple touch points when multiple touch points are detected and receiving text or a control command corresponding to at least one touch point of the multiple touch points when the at least one touch point is detected as being moved.

2. The vehicle of claim 1, wherein the controller is configured to display a first text input indicator on the touch screen, which sequentially displays text or a control command allocated to the at least one touch point as the at least one touch point is moved.

3. The vehicle of claim 2, wherein the controller is further configured to control the touch screen to change text or a control command to be displayed in the first text input indicator at predetermined time intervals.

4. The vehicle of claim 2, wherein the controller is further configured to display a second text input indicator on the touch screen, which displays all text or control commands allocated to the at least one touch point.

5. The vehicle of claim 3, further comprising:
a sound output unit to output sound of text or a control command displayed in the first text input indicator.

6. The vehicle of claim 2, wherein the controller is further configured to receive text or a control command displayed in the first text input indicator at a time when the touch is stopped.

7. The vehicle of claim 6, wherein the controller is further configured to display text on the touch screen when the text is input.

8. The vehicle of claim 6, wherein the controller is further configured to change an image displayed on the touch screen in response to a control command when the control command is input.

9. The vehicle of claim 1, wherein the user is a driver of the vehicle.

10. A multimedia apparatus comprising:
a touch screen detecting a position where a touch is input by a user and displaying an image corresponding to the touch; and
a controller allocating text or a control command to multiple touch points when multiple touch points are detected and receiving text or a control command corresponding to at least one touch point of the multiple touch points when the at least one touch point is detected as being moved.

11. The multimedia apparatus of claim 10, wherein the controller is configured to display a first text input indicator on the touch screen, which sequentially displays text or a control command allocated to the at least one touch point as the at least one touch point is moved.

12. The multimedia apparatus of claim 11, wherein the controller is further configured to control the touch screen to change text or a control command to be displayed in the first text input indicator at predetermined time intervals.

13. The multimedia apparatus of claim 12, wherein the controller is further configured to control the touch screen to change text or a control command to be displayed in the first text input indicator in a predetermined first order, when the at least one touch point is moved in a first direction.

14. The multimedia apparatus of claim 13, wherein the controller is further configured to control the touch screen to change text or a control command to be displayed in the first text input indicator in a predetermined second order, when the at least one touch point is moved in a second direction.

15. The multimedia apparatus of claim 11, wherein the controller is further configured to display a second text input indicator on the touch screen, which displays all text or control commands allocated to the at least one touch point.

16. The multimedia apparatus of claim 15, wherein the controller is further configured to control the touch screen to move the second text input indicator on the touch screen as the at least one touch point is moved.

17. The multimedia apparatus of claim 12, further comprising:
a sound output unit to output sound of text or a control command displayed in the first text input indicator.

18. The multimedia apparatus of claim 17, wherein the controller is further configured to control the sound output unit to output sound of a changed text or control command displayed in the first text input indicator, when the text or control command displayed in the first text input indicator is changed.

19. The multimedia apparatus of claim 11, wherein the controller is further configured to receive text or a control command displayed in the first text input indicator at a time when the touch is stopped.

20. The multimedia apparatus of claim 19, wherein the controller is further configured to display text on the touch screen when the text is input.

21. The multimedia apparatus of claim 19, wherein the controller is further configured to change an image displayed on the touch screen in response to a control command when the control command is input.

22. The multimedia apparatus of claim 10, wherein the user is a driver of a vehicle.

23. A method for controlling a multimedia apparatus, the method comprising:
detecting at least one touch point where a touch is input by a user;
allocating text or a control command to multiple touch points when multiple touch points are detected;
receiving text or a control command corresponding to at least one touch point of the multiple touch points when the at least one touch point is detected as being moved; and
displaying an image that corresponds to the text or control command.

24. The method of claim 23, further comprising:
sequentially displaying text or a control command allocated to the at least one touch point as the at least one touch point is moved, when the at least one touch point is detected as being moved.

25. The method of claim 24, wherein the sequentially displaying of the text or control command allocated to the at least one touch point comprises changing the text or control command at predetermined time intervals.

26. The method of claim 24, further comprising:
displaying all text or control commands allocated to the at least one touch point, when the at least one touch point is detected as being moved.

27. The method of claim 24, further comprising:
outputting sound of the text or control command allocated to the at least one touch point, when the at least one touch point is detected as being moved.

28. The method of claim 24, further comprising:
receiving text or a control command displayed at a time when the touch is stopped.

29. The method of claim 28, wherein the displaying of the image that corresponds to the text or control command comprises:
displaying text when text is input; and
changing the image in response to a control command when a control command is input.

30. The method of claim 23, wherein the user is a driver of a vehicle.
